(19) United States
(12) Patent Application Publication
(10) Pub. No.: US 2012/0064495 A1
(43) Pub. Date: Mar. 15, 2012

(54) TRAINING SYSTEM

(75) Inventors: Robert Tybon, Queensland (AU); Geoff Harris, Queensland (AU)

(73) Assignee: PANTHER INTERNATIONAL PTY LTD., Loganholme, Queensland (AU)

(21) Appl. No.: 13/321,695

(22) PCT Filed: May 26, 2009
(86) PCT No.: PCT/AU2009/000659

§ 371 Date: Nov. 21, 2011

(51) Int. Cl. G09B 19/00

(52) U.S. Cl. 434/247

(57) ABSTRACT

A training system (10) has a number of motion detection units (12) which are triggered in sequence. Each motion detection unit (12) has a radar transmitter (26) for transmitting a radar beam (34), a radar receiver (28) and an indicator in the form of LED lamps (18) and a buzzer (20). A control system (13) triggers each motion detection unit (12) according to a sequence to activate the LED lamps (18) and a buzzer (20). The sequence simulates a game or a training exercise, or may be randomly generated. The motion detection units (12) are operable to de-activate the indicators when the radar receiver (28) detects a radar reflection from an object passing through the radar beam (34).

This invention relates to a training system. In particular, although not exclusively, the invention relates to a training system having a number of motion detection units which are triggered in sequence.

### BACKGROUND TO THE INVENTION

Training systems requiring trainees to satisfy a sensor in response to audio or visual stimuli are well known and widely accepted training tools. Such systems may be as simple as training keyboards having keys which light up to guide a novice player. Such training systems also include reflex reaction test boards which have a grid of lights which a player strikes at as the lights randomly light up, thereby to test reflex reaction.

A complex sports training systems is described in United States Patent Application US 2007/02132126 in the name of Fusion Sport International (the “Fusion Sport patent”). The Fusion Sport patent describes a training system having a number of gates through which an athlete runs to break an “optical tape” between the gates. The optical tape is a light beam transmitted between the gates. When the beam is broken by an athlete passing between the gates, a simple event signal is sent back to a control unit. The athlete is alerted to run through different gates by audio or visual stimuli at the gates.

One of the drawbacks of the system described in the Fusion Sport patent is the requirement to have two spaced apart devices to provide a single gate, which means a lot of equipment is necessary to simulate a path for the athlete. Applicability of the Fusion sports system is also limited to sports in which an optical tape trigger is sufficient to track the athlete. Setting up spaced gates with a light beam between them can be time consuming and laborious as the gates have to be carefully aligned in order for the optical tape to operate. The gates may also be knocked over, disrupting training and optical technology is fragile so there is a real risk that the gates may be damaged.

The system described in the Fusion Sports patent will, for example, not be ideal for racquet sports, where the instantaneous position of the racquet is of more importance than the position of the player. Gates on a racquet court will not allow for freedom of movement of the player. If the optical tape is to be broken by the racquet of the player, the gates themselves will inhibit the stroke that can be played as the natural stroke would be across the gate and the risk of gates being knocked over is increased.

### OBJECT OF THE INVENTION

It is an object of the invention to overcome or at least alleviate one or more of the above problems and/or provide the consumer with a useful or commercial choice.

### DISCLOSURE OF THE INVENTION

In one form, although it need not be the only or indeed the broadest form, the invention resides in a training system comprising:

one or more motion detection units, each motion detection unit having a radar transmitter for transmitting a radar beam, a radar receiver and an indicator; and

a control system which triggers each motion detection unit according to a sequence to activate its indicator;

wherein the motion detection units are operable to de-activate the indicator when the radar receiver detects a radar reflection from an object passing through the radar beam.

According to another aspect of the invention there is provided a motion detection unit including:

a radar transmitter for transmitting a radar beam, and a radar receiver; and

an indicator which is activated when the motion detection unit is triggered by a control system;

wherein the motion detection unit is operable to de-activate the indicator when the radar receiver detects a radar reflection from an object passing through the radar beam.

The sequence may simulate a game or a training exercise, or the sequence may be a randomly generated sequence.

According to yet another aspect of the invention there is provided a method of training including:

triggering motion detection units in a sequence to activate an indicator associated with each motion detection unit;

detecting a radar reflection from an object passing through a radar beam of a triggered motion detection unit; and

de-activating the indicator when the radar reflection is detected.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1 shows a diagrammatic layout of one embodiment of the training system in accordance with the invention comprising a motion detection unit and a control system;

FIG. 2 shows a perspective view of the motion detection unit of FIG. 1;

FIG. 3 shows an electrical diagram of the motion detection unit of FIG. 1;

FIG. 4 shows a logical flow diagram of the control of the control system of FIG. 1;

FIG. 5 shows a diagrammatic plan view of four motion detection units of FIG. 1, placed on the floor of a squash court;

FIG. 6 shows a diagrammatic plan view of another layout of the four motion detection units of FIG. 1, placed on the floor of a squash court;

FIG. 7 shows a diagrammatic perspective view of six detection units of FIG. 1, with two of the detection units mounted against sidewalls of a squash court and the remainder placed on the floor of the squash court in the same arrangement as FIG. 5 of the drawings; and

FIG. 8 shows a perspective view of the training system of FIG. 1 including a biometric sensor which transmits biometric data to the control system of FIG. 1 via motion detection units.

FIG. 9 shows a perspective view of the training system of FIG. 1 including a biometric sensor which transmits biometric data directly to the control system of FIG. 1.

Those skilled in the art will appreciate that minor deviations from the symmetrical layout of components as illustrated in the drawings will not detract from the proper functioning of the disclosed embodiments of the present invention.

### DETAILED DESCRIPTION OF THE INVENTION

One embodiment of the present invention comprises a number of motion detection units and a control system which triggers the motion detection units in a sequence to activate an indicator associated with each motion detection unit. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

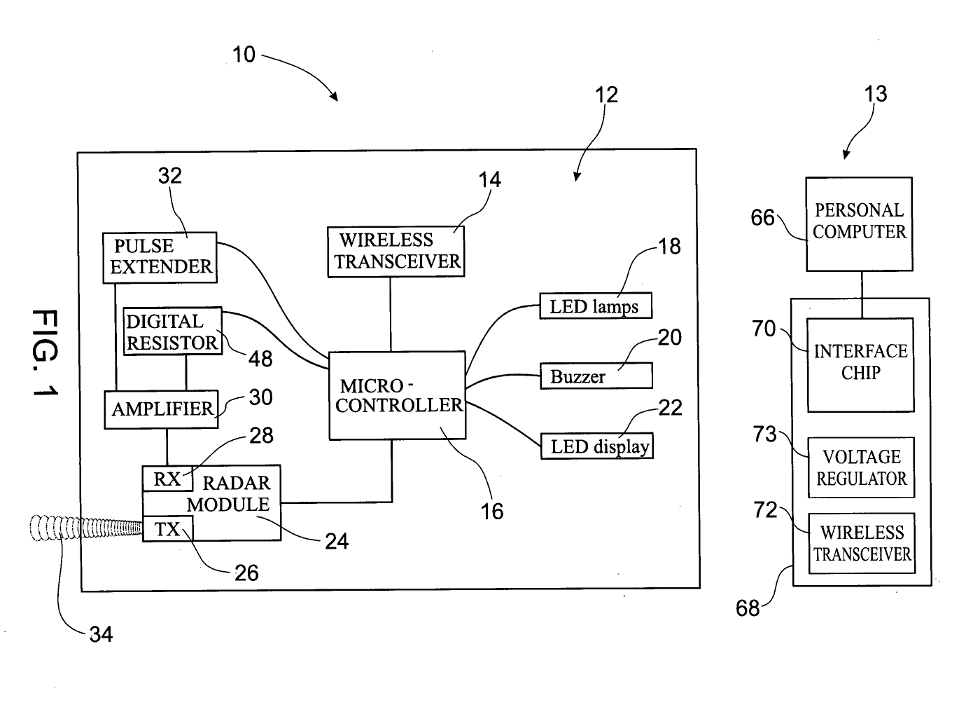

Referring to FIG. 1, one embodiment of a training system in accordance with the invention is designated generally by reference numeral 10. The training system 10 comprises a number of detection units 12 (only one shown) and a control system 13 to control triggering of the detection units 12.

Generally, the detection units 12 comprise: a wireless transceiver 14, a micro-controller 16, indicators in the form of LED lamps 18 and a piezoelectric buzzer 20, LED display 22, a radar module 24 having a transmitter (TX) 26 and a receiver (RX) 28, a two stage analogue amplifier 30, digitally controlled resistors 48, and a pulse extender 32.

The wireless transceiver 14 is in the form of a XBee transceiver, well known in the art of wireless communication. The transceiver 14 provides for wireless communication between all detection units 12. The transceiver 14 is connected to the micro-controller 16. The microcontroller 16 has programmed firmware executed thereon which controls the function of the detection units 12. The detection units 12 can communicate with each other and also with the control system 13.

Activation and de-activation of the LED lamps 18 and the buzzer 20 is controlled by the micro-controller 16. In a sleep mode of the detection unit 12, the lamps 18 and buzzer are not energized. When the detection unit 12 is triggered out of its sleep mode by the control system 13, the lamps 18 and buzzer 20 are activated. The detection units 12 are triggered out of sleep mode through commands sent from the control system 13. When activated, the lamps 18 emit a bright light and the buzzer 20 an audible sound. The lamps 18 can be operated in either a pulsating mode or continuous mode, depending on preference.

The LED display 22 is driven by the microcontroller 16. Each control unit 12 has a unique ID assigned to it, which is displayed by the display 22. Knowing the ID of each detection unit 12 is important for placement of the detection units 12 on a training field or court. The display 22 can display a variety of information, including: battery status, beam strength, and ID. The LED display 22 can also display instructions.

The radar module 24 is operable to detect a passing object. The radar module is a commercially available DNET DNS-101 radar module. The radar module 24 has the specifications given in the table below:

| Transmitter 26 | Receiver 28 | Module Characteristics |
|---|---|---|
| Frequency: | Sensitivity (10 dB S/N | Power/Temp. Coefficient |
| 10.525 GHz. | ratio) in 3 Hz to 80 Hz | (over operating temp. |
| | bandwidth: −85 dBm | range): 3 dB |
| Frequency Setting | Noise in 3 Hz to 80 Hz | Frequency/Temp. |
| Accuracy: 3 MHz | bandwidth: 10 μV | Coefficient (over |
| | | operating temp. range): |
| | | 6.5 MHz |
| Power Output | Antenna Gain: 8 dBi | Operating Temperature |
| (Min.): 13 dBm EIRP | | Range: −20° C. to |
| | | +55° C. |
| Harmonic Emissions: | E Plane 3 dB Beam | Maximum Detection |
| −30 dBm | width: 40′. H Plane | Range: 15M~20M |
| | 3 dB Beam width: 80′ | |

The radar module 24 of the detection unit 12 is activated only when the detection unit 12 is triggered out of its sleep mode. Once triggered, the micro-controller 16 switches on power to the radar module 24 for activating the radar module 24. The transmitter 26 of the radar module 24 transmits a radar beam 34 from the detection unit 12. The range of motion detection can be varied by sending appropriate commands from the micro-controller 16 to the digital resistor 48 to control the gain of the analogue amplifier 30. The range can be varied between as little as 1 cm, up to 20 metres. Different applications of the training system 10 will require the range of motion detection to be different. The receiver 28 receives any radar reflections which a body passing through the radar beam 34 may create. Such a radar reflection produces a pulse in the receiver 28. The pulse is amplified by the amplifier 30 and extended by the pulse extender 32. The pulse is then relayed to the microcontroller 16 as an input. Once the pulse is received, the micro-controller 16 de-activates the radar module 24, and puts the lamps 18, buzzer 20 and LED display into sleep mode. The radar module 24 is always activated in the triggered state of the detection unit 12. It may, however, be turned off by a preset time-out or master reset command and is turned off in the sleep mode. The preset time-out is a pre-determined time from when the radar module 24 was activated elapsing.

The detection units 12 may include other sensors connected to the micro-controller 16. These may include pressure mats, infrared motion sensors and other proximity sensors. All of the sensors would have the same functionality as the radar module 24, in that they report an event to the micro-controller 16.

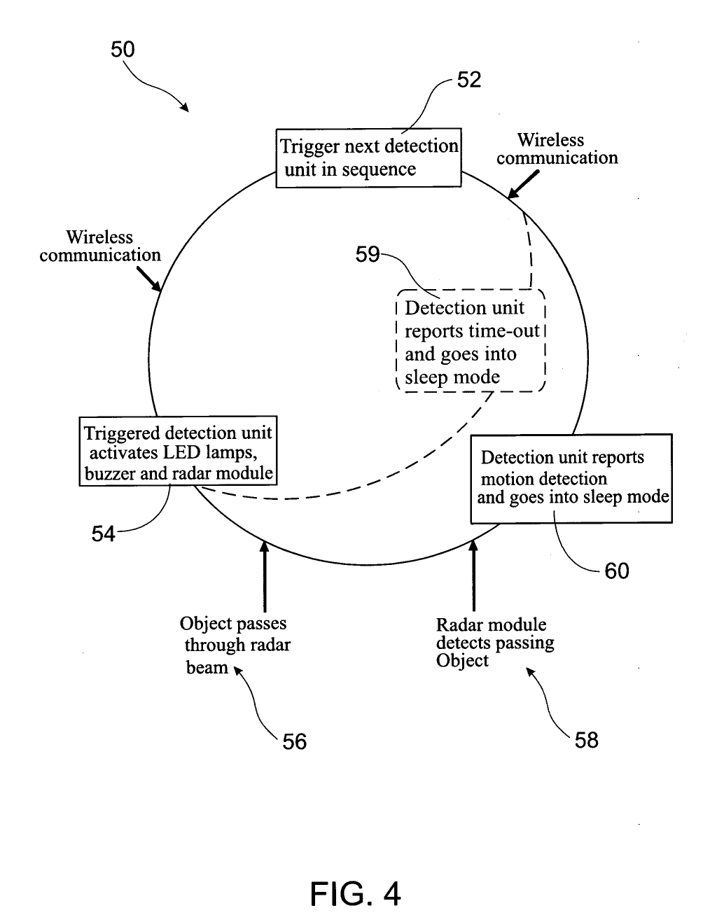

The control system 13 includes a Personal Computer (PC) 66 and a master unit 68 connected to the PC 66. The master unit 68 has a wireless transceiver 72 which is the same as the wireless transceiver 14 of the detection units 12, to facilitate communication with the detection units 12. The master unit 68 includes an interface chip 70 to which the PC 66 connects to facilitate communication with the master unit 68 and the detection units 12. The master unit 68 further includes a voltage regulator 73. The interface chip 70 is a commercially available FT232R chip. The PC 66 has a game program or training program which can be run by the PC 66 to directly control the detection units 12 via the master unit 68. Alternatively, program instructions of the game program or training program is loaded to an electrically erasable programmable read-only memory (EEPROM) of the micro-controller 16 of each detection unit 12 and executed by the micro-controller 16 so that the detection units 12 function autonomously. Depending on the instructions in the programs, the detection units 12 are triggered in a sequence (which may be a predetermined sequence or a randomly generated sequence). The sequence is advanced based on detection feedback from detection units 12 or a time-out of non detection, whichever occurs first. Detection of a passing object by a detection unit 12 is communicated to the master unit 68 by the micro-controller 16 via the transceiver 14. The sequence has pauses between consecutive triggering. As such, the sequence is advanced at a tempo. Control of the detection units 12 are discussed in more detail with reference to FIG. 4.

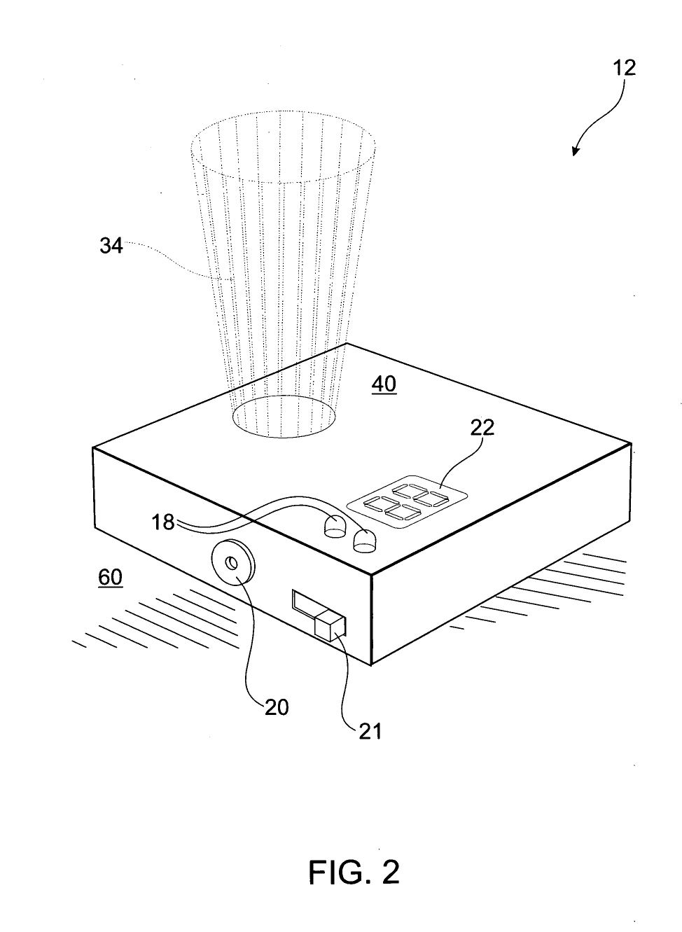

Referring to FIG. 2, the detection units 12 are generally box-shaped, having an housing with an underside and an upper panel 40. The housing is of plastics material. The detection unit 12 is configured so that when the underside is placed on a planar substrate, the radar beam 34 is transmitted substantially perpendicular to the substrate. The underside is placed on a substrate such as the floor of the squash court 60 or a wall of a squash court. The LED lamps 18 extend through the upper panel 40 to be visible. The LED display 22 is mounted flush in the upper panel 40. The piezoelectric buzzer 20 is mounted at a side of the detection unit 12. The detection unit 12 includes an on/off switch 21 to turn the detection units on or off. In the triggered state of the detection unit 12, the radar beam 34 projects substantially vertically upwardly out of the detection unit 12.

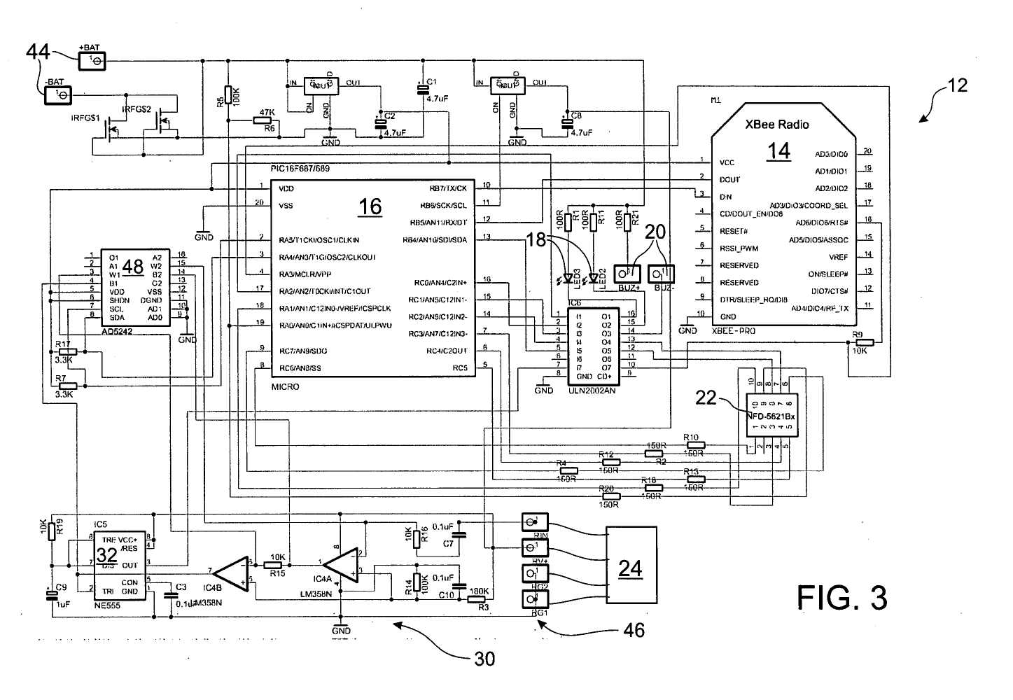

Referring to FIG. 3, an electrical diagram of one of the detection units 12 is shown. Components of the detection units 12 depicted in FIG. 1 are indicated by the same reference numerals in FIG. 3. The detection unit 12 is powered by batteries (not shown) connected to via terminals 44. The radar module 24 is connected to the rest of the circuitry by connectors 46. The gain of the amplifier 30 is controlled by digitally programmable resistors 48, which are in turn controlled by the micro-controller 16.

Referring to FIG. 4, a logical flow diagram 50 of the function of the control system 13 of the training system 10 is shown. The detection units 12 are triggered 52 in sequence by the master unit 68 in a sequence determined by the game program or training program executed by the PC 66. When triggered, the detection units 12 activate the LED lamps, buzzer and radar module, as indicated by reference numeral 54. After the lamps, buzzer and radar module are activated, the control system waits for detection of an object to pass through the radar beam (indicated by reference numeral 56) or for a time-out (indicated by reference numeral 59). In the former instance the radar module of the detection unit 12 detects the passing object, as indicated by reference numeral 58. The detection unit 12 then reports the detection of motion to the master unit and goes into sleep mode, as indicated by reference numeral 60. In the latter instance, the detection unit 12 reports a time-out to the master unit once a pre-determined time has elapsed since the detection unit was triggered and without there having been any detection of a passing object.

In sleep mode, the buzzer, radar module and lamps are de-activated, thereby saving battery power. The report of the motion detection is relayed to the control system by the wireless communication between the detection units 12. The report will include the ID of the detection unit. The next detection unit 12 is then triggered out of sleep mode in the sequence controlled by the control system. Depending on the program instructions being executed by the control system, there may be a delay between one detection unit 12 going into sleep mode and the next detection unit 12 being triggered. It must be appreciated that the subsequent detection unit 12 to be triggered may also be the detection unit 12 which has just gone into sleep mode. Specifically, the program of the control system includes a sequence for simulation of a game or a training exercise. As such, the predetermined time for time-out may be so short that it is impossible for the trainee to reach the detection unit before the next detection unit is triggered. This is known as “wrong footing”, as the trainee is alerted to one detection unit and upon initial reaction another detection unit is triggered. Alternatively, the sequence is randomly generated. The control system records the trigger and motion detection events to the PC software for real-time analysis and storage.

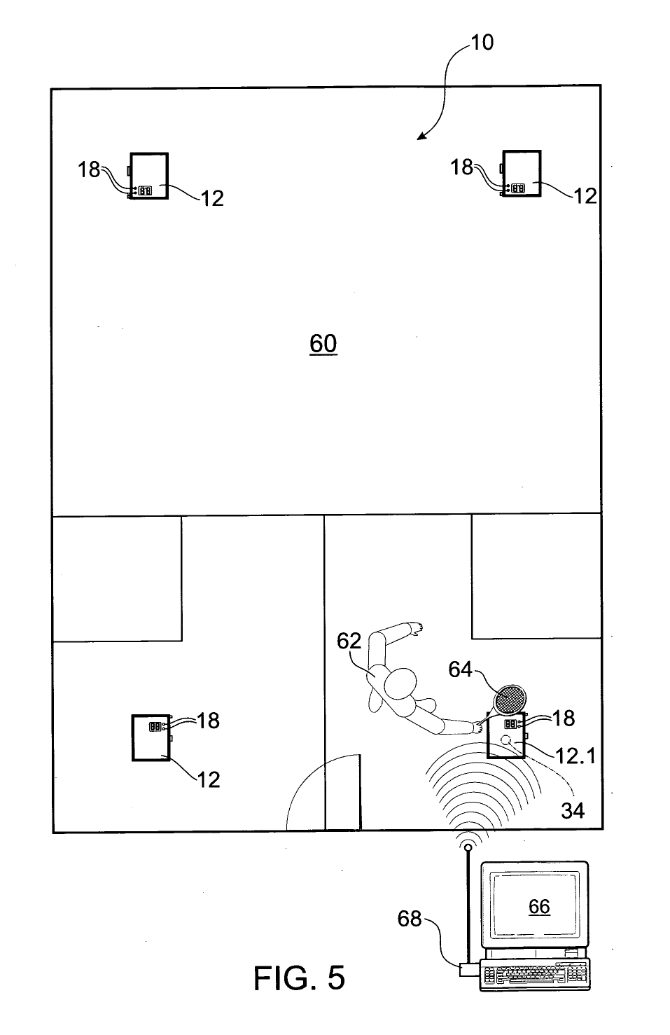

Referring to FIG. 5, a diagram illustrates a layout of four motion detection units 12 of a training system 10. The detection units 12 are placed on a squash court 60 and are in wireless communication with each other and the PC 66. The detection units 12 are placed proximate the four corners of the squash court 60. The PC 66 has software loaded therein which includes a number of game programs, training exercise programs or random programs. Depending on the particular program chosen, the PC 66 displays instructions to a user of the training system 10 of where the detection units 12 are to be placed. Placement of the detection units 12 are facilitated by the ID's of the detection units being displayed on the LED displays 22. The instruction on the PC 66 may, for example, be that detection unit ID “1” is placed in the left front corner, detection unit ID “2” placed in the front right corner, detection unit ID “3” placed in the rear left corner and detection unit ID “4” in the rear right corner. The ID's to be displayed on the detection units 12 are controlled by the PC 66. During training, the master unit 68 triggers the detection units 12 in sequence to coordinate activation of their lamps 18, buzzers 20 and radar beam 34. Each trigger of a motion detection unit 12 alerts the trainee 62 that he/she must play a shot over that detection unit 12 by passing the head 64 of his racquet over the detection unit 12. By playing a shot correctly over the detection unit 12, the head 64 of the racquet passes through the radar beam, thereby reflecting the radar beam 34 so that a signal is generated by the radar receiver of the detection unit 12. The height at which the head 64 must pass above the detection unit 12 to be detected can be varied by varying the gain of the amplifier 30 of the detection units with the digital resistors 38. The buzzers are especially useful if the trainee 62 is facing forward and one of the back detection units 12 are triggered. In FIG. 5, the detection unit 12.1 is shown as the currently triggered unit. The applicant envisages that the lamps 14 may be of different colour, and may be activated individually. Each colour lamp 14 would present a different instruction to the trainee 62 of what action is required to be performed. Instructions could also be presented to the trainee 62 on the LED display 22. This may, for example, indicate a different shot to be played by the trainee 62. The different colours of the lamps 18 may be mirrored by different frequencies for the buzzer 20. It is possible that two detection units are triggered simultaneously and the trainee must then decide which detection unit 12 to attend to first. Similarly, the same detection unit 12 may be triggered consecutively.

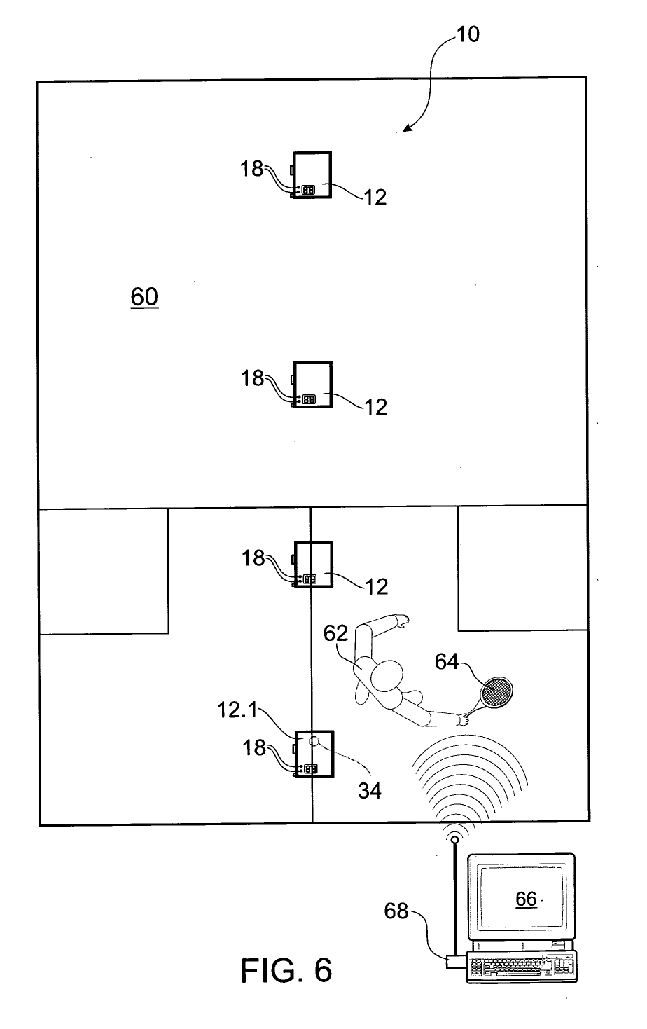

Referring to FIG. 6, another layout of detection units 12 on a court 60 is shown. The training system of FIG. 6 has for detection units spaced along the centreline of the squash court 60.

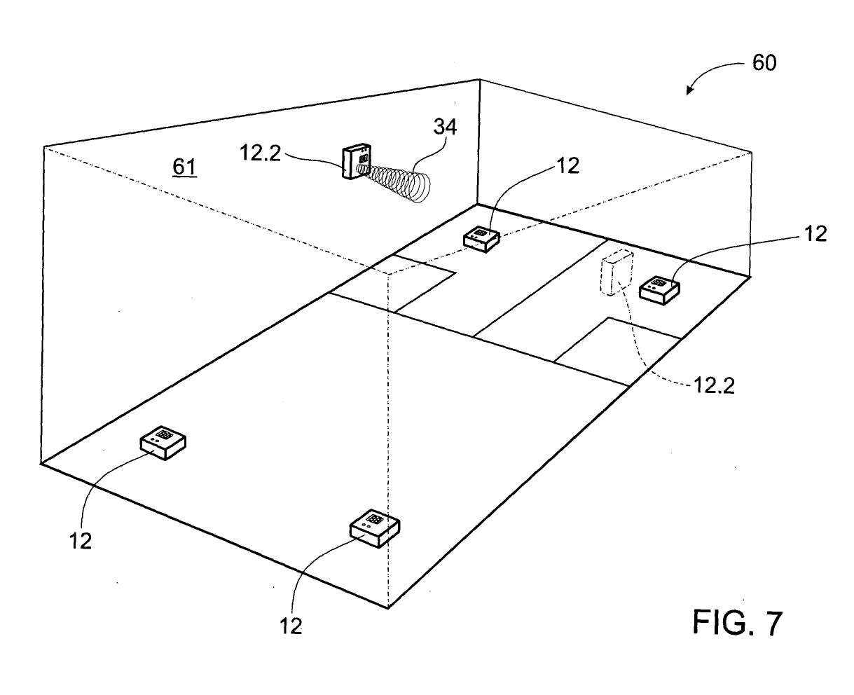

Referring to FIG. 7, yet another layout of detection units 12 on a court 60 is shown. The training system of FIG. 7 includes six detection units 12. Two of the detection units 12.2 are mounted against sidewalls 61 of the squash court 60 and the remainder placed on the floor of the squash court 60 in the same arrangement as FIG. 5 of the drawings. The detection units 12.2 are mounted in an orientation wherein their radar beams 34 project substantially horizontally. The detection units 12.2 are tripped by the head of a racquet passing through the radar beam 34 when the trainee plays a volley stroke.

The training system 10 provides an advanced training tool for coaches and athletes. Although the embodiment described for the training system 10 referred specifically to squash, it must be appreciated that the training system 10 may be used to simulate any sport or situation where trainees are alerted to trigger remote motion detection units. The training system 10 may, for example, be used in tactical training for fire fighters or response units, athletics training, football training etc. Any number of detection units 12 mounted in any orientation may be used, depending on the resolution and position of alerts required for a given training program or exercise program. As illustrated in FIGS. 5, 6 and 7, the detection units 12 may be placed on the ground so that the beam 34 projects upwardly and may be mounted in any orientation so that the beam 34 can project horizontally or in any other orientation. With the detection units 12 flat on the ground and the beam 34 projecting upwardly, the training system 10 is particularly suited to racquet sports. The detection units 12 are equally suitable for use in the applications described in the Fusion Sport patent, by mounting the detection units 12 sideways so that the beam 34 projects horizontally. The detection units 12 may be mounted at an elevated position on stands. A further advantage of the detection units 12 is that the beam 34 can “see” through material such as glass or plastic, so that the units may be strategically be placed behind props. Yet a further advantage of the detection units 12 is that they are not overly intrusive in the training space and do not hamper movement of the trainee. As is readily evident, the training system 10 is easily configurable and adaptable to different sports and requirements.

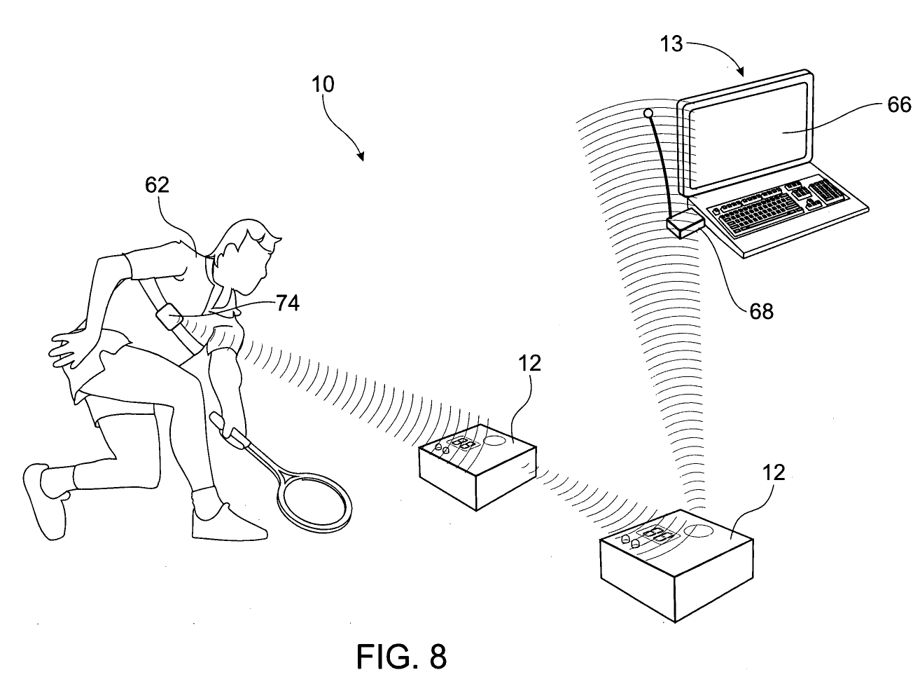

Referring to FIG. 8, the training system 10 further includes biometric data capturing and biometric data dependant control. The trainee 62 wears a biometric feedback sensor such as a heart rate monitor 74 having a wireless transmitter which transmits heart rate data. The heart rate data is transmitted to the master unit 68 by relaying the data along the detection units 12. As will readily be understood, the wireless transmitter of the heart rate monitor 74 has only to be powerful enough to transmit the heart rate data to the closest detection unit 12. This allows the heart rate monitor 74 to be designed sufficiently compact to be worn by the trainee and limits the drain on the batteries of the heart rate monitor 74. The heart rate data is used as an input to the game program or training program of the training system 13, which then modifies the tempo or sequence of trigger of the detection units 12 depending on the heart rate data. For example, if the training program has as its goal to keep the heart rate of the trainee 62 in a zone specified by the control system, the control system 13 will either speed up or slow down the tempo of triggering the units 12 if the heart rate data shows that the trainee's heart rate has moved out of the specific zone. Similarly, there may be many different fitness programs where the goal is to vary the trainee's heart rate and the control system 13 will either speed up or slow down the tempo of triggering the detection units 12 to achieve the desired changes in the trainee's heart rate.

To further optimize the power usage of the heart rate monitor 74 (and thus allow for compact design), the heart rate monitor 74 has a logic controller which is programmable to have the heart rate monitor 74 only transmit heart rate data which indicates that the trainee's heart rate has jumped between predefined bands of heart rate and which band it has jumped to. The heart rate monitor 74 thus monitors the real-time heart rate, but the only heart rate data that is transmitted by the transmitter is when the heart rate jumps between the predefined bands of heart rate.

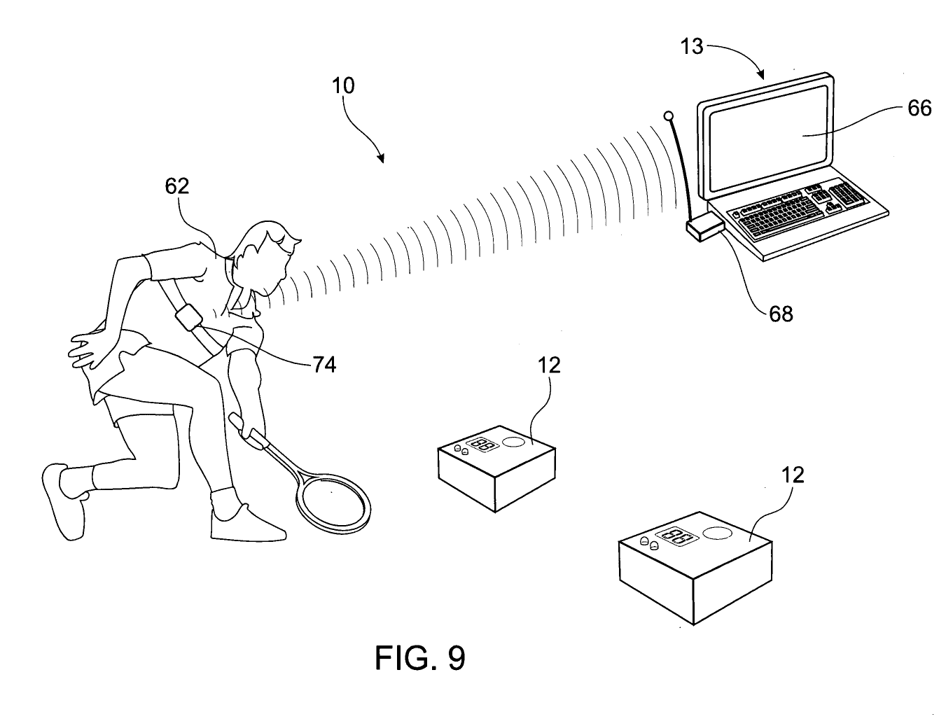

Referring to FIG. 9, the training system 10 is configured so that the biometric data is transmitted directly from the heart rate monitor 74 to the master unit 68. In this embodiment the master unit has a separate receiver for receiving biometric data from the heart rate monitor 74. The heart rate monitor 74 of FIG. 9 has a low power radio frequency (RF) transmitter which transmits the biometric data directly to a RF receiver in the master unit 68.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. For example, the control system for the training system may comprise one of the detection units being a master detection unit and the remainder of the detection units being slave detection units controlled by the master detection unit. The training system will thus comprise a number of detection units which are autonomously operable under the control of one of the detection units. Accordingly, this patent specification is intended to embrace all alternatives, modifications and variations of the present invention that have been discussed herein, and other embodiments that fall within the spirit and scope of the above described invention.

1.-33. (canceled)

34. A training system comprising:
one or more motion detection units, each motion detection unit having a radar transmitter for transmitting a radar beam, a radar receiver and an indicator; and
a control system which triggers each motion detection unit according to a sequence to activate its indicator;
wherein the motion detection units are operable to de-activate the indicator when the radar receiver detects a radar reflection from an object passing through the radar beam.

35. The training system of claim 1, wherein triggering of a motion detection unit includes activating its radar transmitter and radar receiver and wherein the motion detection units are configured to de-activate their radar transmitter and radar receiver upon the radar receiver detecting the radar reflection from an object passing through the radar beam.

36. The training system of claim 1, wherein the sequence simulates a game or a training exercise.

37. The training system of claim 1, wherein the sequence is a randomly generated sequence.

38. The training system of claim 1, wherein the motion detection units each have a wireless communication module and the motion detection units are in wireless communication with each other.

39. The training system of claim 1, wherein the control system includes a master unit that controls triggering of the motion detection units and the master unit includes a wireless communication module for wireless communication with the motion detection units.

40. The training system of claim 1, wherein the motion detection units include a variable amplifier so that the range at which the radar receiver detects the radar reflection is variable.

41. The training system of claim 1, wherein the training system includes a biometric feedback sensor which includes a transmitter to transmit biometric data to the control system and the control system is configured to vary the sequence or tempo of trigger of the motion detection units depending on the biometric data.

42. The training system of claim 8, wherein the biometric data is wirelessly transmitted to the control system.

43. A motion detection unit including:
a radar transmitter for transmitting a radar beam, and a radar receiver; and
an indicator which is activated when the motion detection unit is triggered by a control system;
wherein the motion detection unit is operable to de-activate the indicator when the radar receiver detects a radar reflection from an object passing through the radar beam.

44. The motion detection unit of claim 10, which further includes a wireless communication module which is operable to communicate with a master unit.

45. The motion detection unit of claim 10, which further includes a wireless communication module which is operable to communicate with other motion detection units.

46. The motion detection unit of claim 10, which further includes a programmable memory having program instructions of the control system thereon which are executed to trigger the other motion detection units in a sequence.

47. A method of training including:
triggering motion detection units in a sequence to activate an indicator associated with each motion detection unit;
detecting a radar reflection from an object passing through a radar beam of a triggered motion detection unit; and
de-activating the indicator when the radar reflection is detected.

48. The method of training of claim 14, wherein the sequence simulates a game or a training exercise.

49. The method of training of claim 14, wherein the sequence is randomly generated.

50. The method of training of claim 14, including de-activating the indicator at a pre-determined time from when it was activated, if the indicator has not already been de-activated by detection of the radar reflection.

51. The method of training of claim 14, including advancing the sequence upon the radar receiver of one of the motion detection units detecting the radar reflection from an object passing through the motion detection unit's radar beam.

52. The method of training of claim 18, including advancing the sequence upon the pre-determined time from when the indicator was activated elapsing, if the sequence had not already been advanced by detection of the radar reflection.

53. The method of training of claim 14, including measuring biometric data and varying the sequence or tempo of triggering depending on the biometric data.
